(19) United States
(12) Patent Application Publication
(10) Pub. No.: US 2012/0103178 A1
(43) Pub. Date: May 3, 2012

(54) ARMOUR, IN PARTICULAR PASSIVE ARMOUR, USE OF A COMPOUND IN AN ARMOUR AND A METHOD FOR MANUFACTURING

(75) Inventor: Johannes Petrus Dijkman, Landhorst (NL)

(73) Assignee: Rudy Hendrik Gerard KOSTER, Amsterdam Zuidoost (NL)

(21) Appl. No.: 13/375,933

(22) PCT Filed: Jun. 2, 2010
(86) PCT No.: PCT/NL10/50331

§ 371 Date: Jan. 6, 2012

(30) Foreign Application Priority Data
Jun. 2, 2009 (NL) 2002952

(51) Int. Cl. F41H 5/02; B29C 67/24; F41H 7/02; F41H 5/04; F41H 5/08; F41H 5/24

(52) U.S. Cl. 89/36.02; 264/109; 89/903; 89/930; 89/904

(57) ABSTRACT

An armour (23, 39) for protecting an object from a projectile includes a layer of granulate salt (21, 26, 31, 51) at least partially surrounding the object. In an embodiment, the granulate material (21, 26, 31, 51) is Sodium Chloride (NaCl). Also disclosed is a combined armour plate (39), including a first layer of granulate material (31), wherein the granulate material is compressed with a pressure of at least 2 Atm; and a second layer of traditional armour (33), wherein the first layer (31) is located closer to the outside or impact side of the armour plate than the second layer (33). A method of forming an armour (23, 39) includes providing a granulate salt (21, 26, 31, 51) and pressing the granulate salt in a container (22, 25 30).

The invention relates generally to armour. More specifically, the invention relates to passive armour elements for protection against shaped charges. The invention further relates to a method of forming an armour.

The need for armour for vehicles, static structures, and human bodies is well known. Armour may protect against for example stabbing weapons and, particularly, flying projectiles such as grenades, bullets, and shrapnel.

Of specific note are shaped charge explosives, which are very effective at penetrating traditional armour such as steel plates. Shaped charge explosives, first developed after World War I, are typically used as warheads in for example anti-tank missiles or gun-fired projectiles, but also find use in mines, grenades, torpedoes, and other weaponry.

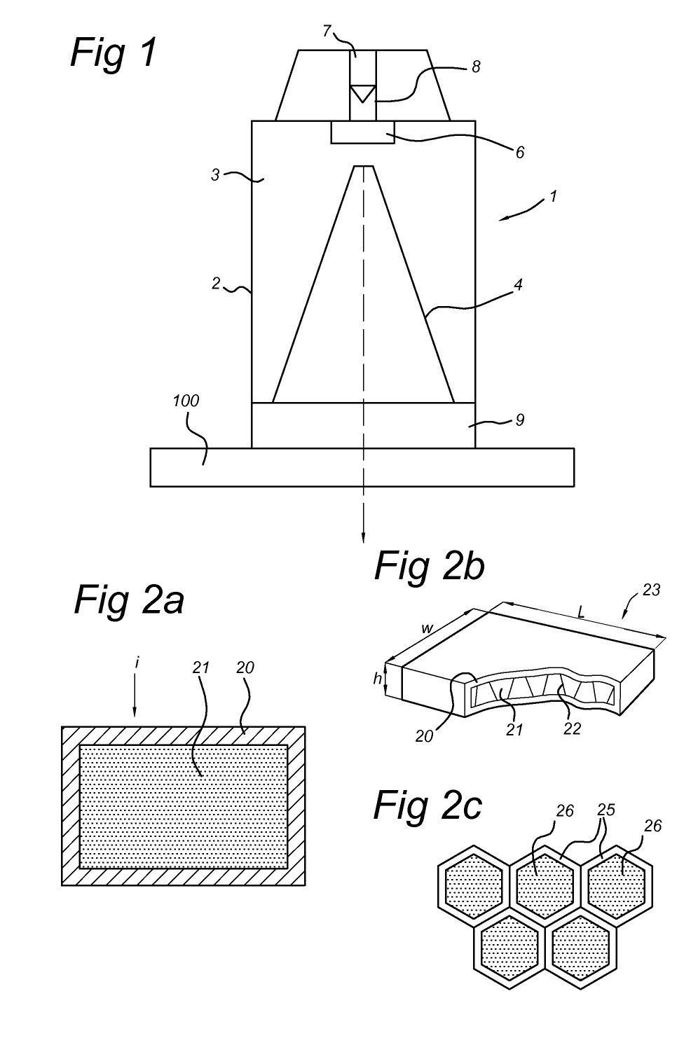

FIG. 1 shows an example of a shaped charge explosive 1. It comprises a housing 2, inside which is an amount of explosive material 3 surrounding a hollow cone 4, which is typically made of copper. At the top the shaped charge explosive 1 comprises a detonator 6, a passageway 8 and a detonating needle 7.

On impact of the explosive 1 on a target surface 100, the detonating needle 7 will move down the passageway 8 and strike the fuse 6, causing a detonation of the explosive 3. The explosion transforms the hollow cone into a jet of hot metal particles, also called a hollow charge-jet. The jet has a peak velocity between 5 and 10 kilometre per second and a diameter of several millimetres.

In order for the jet, and thus the explosive, to be most effective at penetrating armour, an optimal stand-off distance 9, the distance between the lower end of the cone and the impact surface, is required. It is known that the optimal stand-off distance is approximately three times the diameter of the cone.

The shaped charge jet reaches peak velocity some 40 microseconds after detonation, and the jet then, since the tip reaches a higher velocity than the tail end, stretches out to a length of about 8 cone diameters. The impact of the jet on the target 100, such as a metal armour plate, is at such high velocity that little plastic deformation can occur. Instead, the target material is subject to a brittle fracture. Once the initial fracture has been initiated, the physics of hydrodynamic impact cause both target and jet materials to behave like fluids. Generally the jet's penetrating power is primarily limited by friction between the moving jet and stationary target material, causing the jet to loose velocity and finally come to a stop. As such, a shaped charge jet from a shaped charge explosive causes a much deeper impact than the denotation of a standard projectile with the same amount of explosive material.

One known way of dealing with the improved, compared to traditional explosives, penetration depth of shaped charge explosives is to increase the thickness of traditional armour such as steel plates. However, this has a disadvantage of weight and cost. The weight results, in the case of a vehicle armour, in a reduced moving capacity, both in velocity and in range, of the vehicle.

An other known way of dealing with shaped charge explosives involves so-called reactive armour, see for example U.S. Pat. No. 5,637,824. The purpose of reactive armour is to trigger a secondary detonation, of explosive material contained in the reactive armour, on impact of a shaped charge explosive, thus disturbing the forward thrust of the shaped charge jet, reducing its impact.

While reactive armour seems to be the most common counter measure against shaped charge explosives, it has numerous drawbacks. One disadvantage is the additional danger for surrounding personnel, such as infantry moving with the armoured vehicle. Others are cost, the need to replace detonated armour elements, and cost of safely storing and maintaining explosive material in armour. Furthermore, due to the dangers of the explosions of the armour itself, it is hard to apply reactive armour in confined spaces (such as safe doors in bank vaults) and in armour items for personnel protection, such as bullet-proof vests.

Other measures against shape charge explosives have been proposed, particularly those that attempt to interfere, on the boundary of the (traditional) armour, with the ideal standoff distance of the shaped charge explosive.

For example, U.S. Pat. No. 6,311,605 teaches the use of additional structure elements on the outside of the armour, to interfere with the ideal stand-off distance. In U.S. Pat. No. 6,581,504, a similar effect is attempted by adding inclined surfaces, supported by struts, on the outside of the armour.

Field tests have shown that the success of these measures is limited.

Document WO 2007/146 259 A describes an armour panel comprising a confined particulate structural layer. In some embodiments, the confined particulate structural layer is compressed. Example particulate materials include ceramic powders, ceramic microspheres, glass microspheres, silicon carbide, granulated garnet or other hard gemstones.

Document FR 2 842 590 discloses a reactive armour having an inactive matrix, the matrix comprising an “foamed” (having a cell structure) aluminium—metal hydride alloy. The cells may be filled with spherical bodies having a diameter of a few millimetres, which can be made of glass, ceramic, clay, salt, or metals.

It is an object of the invention to provide passive, non-energetic, armour elements that reduce penetration depths of shaped charges.

It is another object of the invention to provide penetration depth reducing armour elements that have the same weight or a lower weight than the known armour elements.

According to a first aspect an armour, in particular a passive armour, is provided for protecting an object from a projectile comprising a layer of salt at least partially surrounding the object. According to an aspect of the invention, an armour, in particular a passive armour, is provided for protecting an object from a projectile comprising a layer of granulate salt at least partially surrounding the object. Granulate salts can be advantageously used to form a layer for an armour. However, non-granular forms of salt, such as for example grown crystals, may also be used to provide the layer of salt. The layer of granular or non-granular salt may comprise at least 90% or 95% salt, or the layer may be essentially homogeneously composed of salt.

In a traditional type of armour ‘hard’ materials are used, for instance materials having a relatively large amount of interconnections such as Kevlar. Although these types of armour may provide some protection against penetrating projectiles, the level of protection against high energy projectiles, especially against shaped charge projectiles, may be limited. The inventor, however, discovered that a layer of salt is extremely effective as a protective armour element in blocking such high energy projectiles. Salts as such are not known to be useful materials in armours. The inventor discovered to his surprise that a layer of a salt has very advantageous properties in slowing down high-energy projectiles, such as shaped charge jets. One possible explanation of why a layer of salt has relatively good penetration depth reducing properties for incoming high velocity projectiles is as follows.

Grains as such can be penetrated at low velocity, but at high impact velocities the grain particles do not make way fast enough. It is believed that the gaps between the grain particles may act as a thermal insulation. Furthermore, some of the well known and readily available salts have a low thermal conductivity. In accordance with embodiments of the invention the one or more layers of granulate material comprise one or more chemical salts.

Further a particular advantage of grainy salts as armour layers may be the low specific density of the material. The inventor discovered that grainy salts allow forming relatively lightweight armours.

The inventor discovered furthermore that the addition of a grainy salt armour outside a steel plate can allow decreasing the penetration depth of a shaped charge jet in the steel plate considerably. In embodiments of the invention the penetration depth may be reduced with more than 70% compared with traditional armours.

It is further believed that using natural salts, such as a widely available salts, as an armour layer, having irregular shaped grains, increases the properties of decelerating charge jets. Salt particles can have multiples particle size. In an embodiment a large spread in grain sizes is used. In an embodiment the grain size in a layer of the armour according to the invention can be 1%-10000% of an average grain size.

In an embodiment a dielectric salt is used as a layer of armour protection. Dielectric salts are readily available and lower the costs for production of the armour. Further the inventor established, surprisingly, that dielectric salts have a high resistance to shaped charge jets.

In an embodiment the granulate salt is predominantly ionic. The ionic bond comprises at least 70% of the molecule bond of the salt. In an embodiment the salt is a non-mineral. At least some minerals, such as sand, do not show similar armour properties as grainy salts.

In an embodiment the salt has a cubic crystal structure or a interpenetrating face-centred cubic lattice or a fca lattice with a two atom basis. Such crystals or crystalline structures were discovered as having higher penetration resistance to jet charges than well known armours such as hardened steel plates.

In an embodiment the salt comprises of one or more cations of alkali metals. In an embodiment Sodium (Na), Lithium (Li) or Potassium(K) is used as cation for the salt. Further embodiments of the cation include Calcium (Ca) or Magnesium (Mg). In an embodiment single atom cations form the main component of the salt. The single atom cations are less likely to produce (exothermic) reactions as a result of a high energy impact of a projectile.

In an embodiment the salt comprises one or more of anions of halogens. In an embodiment Chlorine (Cl) or Bromine (Br) is used as anion. In an embodiment single atom anions form the main component of the salt. The single atom anions are less likely to produce (exothermic) reactions as a result of a high energy impact of a projectile. In an embodiment the anion is Nitrate (NO2), Sulfate (SO4), or phosphate (PO4).

In an embodiment the granulate material is Sodium Chloride (NaCl). NaCl is a stable substance. It can not burn. NaCl is not poisonous. NaCl is readily available at low costs.

In an embodiment the salt has a molar mass of less than 180 gr/Mol, preferably less than 140 gr/Mol, more preferably less than 100 gr/Mol. In an embodiment, the salt has a density of less than 6 gr/cubic centimetre, preferably less than 4.5 gr/cubic centimetre, more preferably less than 3 gr/cubic centimetre.

It was discovered by the inventors that, contrary to well known standards of using ‘hard’ materials armour plating, relatively soft material can be used as armour against especially charge jets. In an embodiment the salt has a Mohs hardness of less than 6, in an embodiment less than 5. Such softer material might be easily penetrated at low velocities, but offer high resistance to charge jets.

In an embodiment the salt forms a layer with a hardness that is smaller than 20 Vickers. In an embodiment the material used as an armour layer has a hardness that is less than 5 Vickers. Vickers is a standard measure for material hardness. Materials with a low hardness value are relatively easy to penetrate with a slow moving object. However, the inventor discovered that salts with a low hardness have the property that they are hard to penetrate by an object that comes in at a high velocity.

It is advantageous to form a layer for an armour from a granulate salt that is pressed. The armour comprises the compressed grainy material. The inventor discovered that compression enhances the effect of making the material hard to penetrate at high velocities. In an embodiment the grainy salt is compressed with a pressure of more than 1 Atmosphere (Atm), in an embodiment more than 10 Atm, in an embodiment more than 100 Atm, in an embodiment more than 1000 Atm, in an embodiment more than 10000 Atm.

In a further embodiment the salt is received in a enclosure or container. The enclosure or container can allow positioning the salty layer on the object to be protected. The container can be filled with the salt. The container can allow easy storage of the armour. The armour can comprise multiple containers. The containers can allow interconnecting. The container can be closed or partially closed. In an embodiment the container comprises a lit. In an embodiment the container can be refilled with grainy salt to re-strengthen the armour.

In an embodiment a self-repairing container is used. After penetration, the container can form a new closed or partially closed enclosure. The grainy salt can also take the position of material ‘moved’ by the impact. The grainy material is allowed to flow in the enclosure. This will allow a partial reconstruction of the armour after impact.

In further embodiments of the invention a cell of armoured material, grainy salt, enclosed in an container, is provided. The cell itself does not need to be particularly strong, needs to be contained.

The container can be flat box. In an embodiment the containers can be formed to allow forming a layer structure of adjacent containers. In an embodiment the container is honeycomb shaped. Combinations of adjacent containers can form a layer of armour having a honeycomb structure.

In an embodiment steel is used as a container. A steel ring can be used.

In an embodiment the enclosure or container allows pressing the salt and will hold the pressed salt. This will provide an armour cell of a grainy pressed material.

Especially in combination with a steel ring, it will be possible to provide a low cost armour layer of pressed salt held in the steel ring. The container or steel ring preferably forms a small part of the surface layer of the armour.

According to an aspect of the invention armour elements, comprising of cells or containers are provided. The armour elements comprise a layer of a grainy salt, preferably compressed. In an embodiment armour plates comprising the layer of grainy salt is provided.

In an embodiment the armour is arranged for the protection of a vehicle or static structure or arranged for the protection of a person's body.

In an embodiment the armour elements are arranged in overlapping “roof-tile” manner.

In an embodiment salts having a melting point in the order of 400-1000 degrees Centigrade are used as armour.

According to an aspect of the invention a layer of armour is provided using a inorganic compound, preferably a salt and preferably a granulate, having a heat of fusion of at least 4000 cal/mole, in an embodiment at least 5000 cal/mole and in an embodiment at least 6000 cal/mole. An example is NaCl, having a heat of fusion of 7220 cal/mole. Such compounds have a relative high resistance to high energy projectiles.

According to an aspect of the invention use of a salt as a layer for an armour is provided. The inventor discovered that salts have a relative high penetration resistance against shaped charge jets. In an embodiment a granular salt, preferably a non-mineral, is used as armour. The use of the salt as armour can be combined with any of the above indicated structural features.

According to an aspect of the invention, an armour is provided having a layer of salt, wherein the layer of salt comprises at most 10%, or at most 20%, or at most 30% or at most 50% of an additional material. The use of such a salt is provided.

According to an aspect of the invention, the additional material comprises any one or combination of the materials sodium hydroxide, mortar, graphite, carbon, activated carbon, granular activated carbon, sugar, lead, zinc, copper, tombak, nitrates, clay, loam, lime, and calcium. According to an aspect of the invention, these additional materials, which can combine advantageously with the main component, salt, to form an improved layer, can be mixed with the salt and then pressed. Alternatively, these materials may be added to an formed layer comprising mainly salt.

According to yet another aspect of the invention a combined armour plate is provided, comprising a first layer of granulate compound, wherein the granulate compound is compressed with a pressure of at least 10 Atm, and a second layer of traditional armour. The first layer is located closer to the outside or impact side of the armour plate than the second layer. According to an aspect of the invention, said granulate material comprises at least 50%, 60%, or 70% of salt. Preferably, the granulate material comprises at least 75%, 80%, or more preferably 90% or 95% salt

According to a further aspect a method for forming an armour is provided, the method comprising providing a granulate salt and pressing the granulate salt. The inventor discovered that such a pressed salt surprisingly shows a high resistance to high energy projectiles.

In an embodiment the salt is compressed in an enclosure. This allows containing the salt. The enclosure can be part of a container. The container can allow positioning the armour.

The invention provides tanks, structure, human body protection elements comprising armour (cells). Also bullet-proof-vest type, or samurai style can be provided for protection of humans.

The invention will be explained in more detail below with reference to the drawing in which illustrative embodiments of the invention are shown. It will be appreciated by the person skilled in the art that other alternative and equivalent embodiments of the invention can be conceived and reduced to practice without departing from the spirit of the invention, the scope of the invention being limited only by the appended claims.

FIG. 1 schematically shows a prior art shaped charge explosive.

FIGS. 2A-C schematically show basic armour according to an embodiment of the invention.

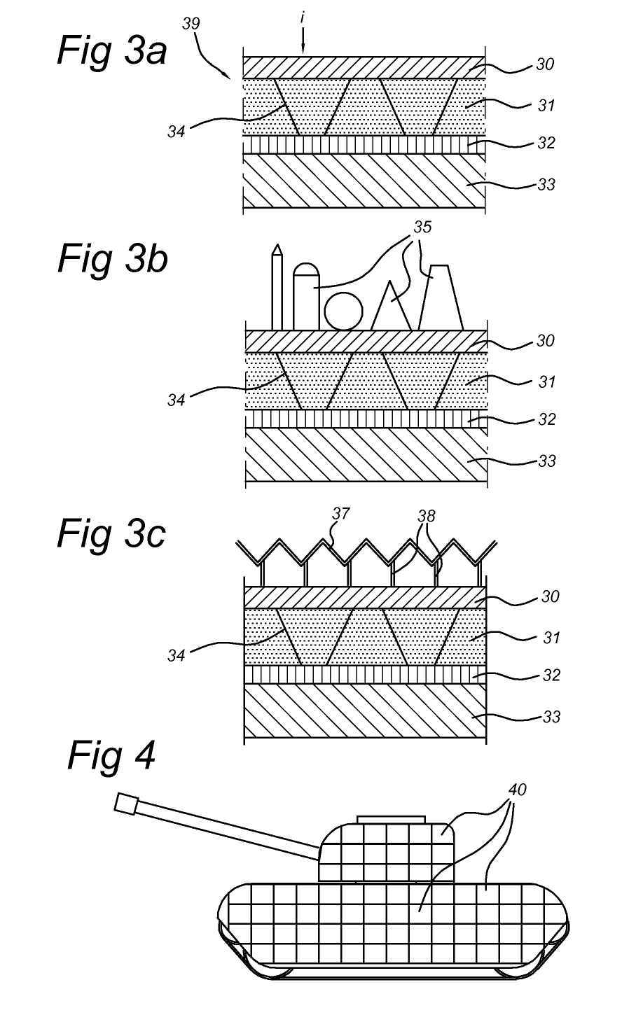

FIGS. 3A-C schematically show combined armour plates according to an embodiment of the invention.

FIG. 4 schematically shows an armoured vehicle according to an embodiment of the invention.

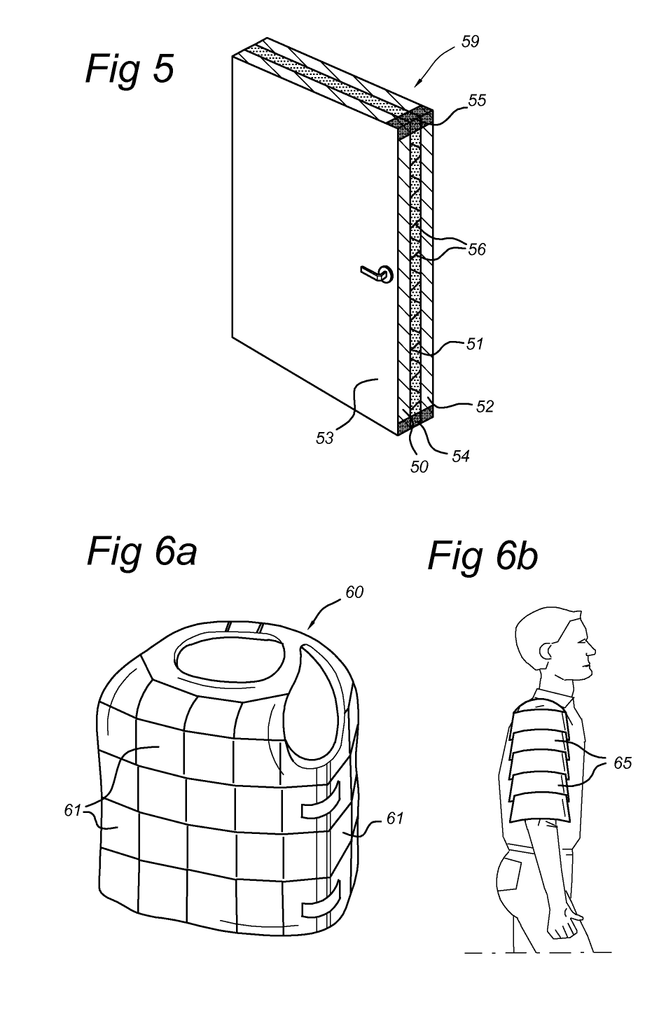

FIG. 5 schematically shows an armoured door according to to an embodiment of the invention.

FIGS. 6A-B schematically show personnel armour according to an embodiment of the invention.

FIG. 2A shows an enclosure or container 20 comprising a filler material 21. The container 20 may comprise a support structure 22.

In an embodiment, the filler material is a granulate material. In an embodiment, the filler material granules or particles have average diameter of 0.1-20 millimetres and more preferably an average diameter of 0.2-10 millimetres.

In a further embodiment, the filler material is a compressed granulate material. The granulate material may be compressed with a pressure of at least 2 Atm, preferably at least 5 Atm, more preferably at least 10 Atm.

In an embodiment, the filler material has a crystalline structure. It may consist of granules or particles of crystalline material. Preferably the filler is a cubic or hexagonal crystalline structure. Preferably the filler material has a cubic close packed arrangement.

The granules or particles of the, in an embodiment crystalline, material may have a hardness of at most 6 Mohs, in an embodiment at most 5 Mohs, preferably at most 4 Mohs.

In an embodiment, the filler material is a chemical salt. In an embodiment, the filler material consists of an ionic compound composed of cations and anions.

In an embodiment, the filler material comprises one or more alkali metals.

In an embodiment, the filler material comprises one or more halogens.

In an embodiment, the filler material is a compound of one or more of Na (Sodium), Ca (Calcium), Li (Lithium), K (Potassium), or Mg (Magnesium) and one or more of Cl (Chlorine), nitrate (NO₃), sulphate (SO₄), and phosphate (PO₄).

A non-exhaustive list of possible combinations is NaCl (salt), CaCl, LiCl, MgCl, KCl, NaNO₃, CaNO₃, LiNO₃, MgNO₃, KNO₃, Na₂SO₄, Ca₂SO₄, Li₂SO₄, Mg₂SO₄, K₂SO₄, Na₃PO₄, Ca₃PO₄, Li₃PO₄, Mg₃PO₄, and K₃PO₄.

Furthermore, it is advantageous to use a filler material 21 that is non-flammable, such as NaCl. Sodium chloride has the particular advantageous of being widely available at low costs.

It is also advantageous if the melting point is such that the material is in solid state at room temperatures. In an embodiment, the filler material has a melting point that is at least 700 K and at most 1500 K, preferably at least 800 K and at most 1300 K.

In an embodiment, the filler material has a heat of fusion of at least 4500 cal/mole.

In an embodiment, the filler material has a density that is at most 4 grams per cubic centimetre, preferably at most 2.5 grams per cubic centimetre.

It is a surprising characteristic that a filler material as described in the preceding, such as for example Sodium Chloride (NaCl) in compressed or uncompressed form, is relatively hard to penetrate for fast moving projectiles, such as shaped charge jets.

The container 20 can be made of metal or plastic. The container 20 walls can be about 5 millimetres thick. In an embodiment the container comprises a tank.

The container 20 may enclose a tile shaped block of filler material 21, for example 20 centimetres in length, 20 centimetres in width, and 5 centimetres in height or thickness. An container 20 comprising filler material 21 with these dimensions can be used to protect against shaped charge jets impacting in an impact direction i along the height of the tile. Thus, the shaped charge jet has to penetrate 5 centimetres of filler material, and a total surface of 20 times 20 equals 400 square centimetres is protected. Obviously, a wide range of dimensions is possible.

The support structure 22 may consists of strut-like elements, at either end connected to the container material, or straight or curved surfaces, also connected to the container material. Many variations of support elements are possible.

The function of the container 20 and filler material 21 is as follows. Consider a shaped charge explosive impacting with impact direction i.

In an embodiment, the function of the container 20 is mainly to protect the filler material inside from e.g. moisture and mechanical stresses. It is not particularly meant to protect against shaped charge explosives.

Therefore, the shaped charge jet that is formed by the detonation of the shaped charge explosive, as discussed in reference to FIG. 1, will likely penetrate the container 20 in the impact direction i. Subsequently, the jet will enter the filler material 21 at or close to its peak velocity, which may be 5 to 10 kilometres per second.

The inventors believe that a filler material 21, such as a chemical salt, such as for example NaCl, does not “flow like a fluid”, like a metal armour does, in the case of a hydrodynamic impact, such as the impact of a shaped charge jet. The structure of the filler material prevents this fluid-like effect. Furthermore, the filler material comes into abrasive contact with the outer layers of the shaped charge jet, causing friction forces which slow the jet down. These effects combined mean that the filler material has a so-called “filler stopping effect” on a shaped charge jet.

Furthermore, the inventors believe that the impact of the shaped charge jet advantageously spreads thermal energy throughout the impact channel in the filler material, causing the filler material, such as NaCl, to melt. The melted filter material further spreads the thermal energy to more remote parts of the filler material. Thus, the kinetic and thermal energy of the shaped charge jet is dispersed.

The support structure 22 can be used, for example, to make the container more rigid, to make the container better withstand mechanical stresses, or to limit the filler material moving inside the container. A more rigid container may advantageously reduce mechanical stress on the contained filler material.

In a first experiment a M42/47 cluster bomb was tested. Such a bomb, comprising 40 grams of C6, can penetrate up to 8 cm of iron arranged in 1 cm iron plates. The same stack of steel plates, now protected by a 3.5 cm layer of a 16 metric tons per square centimetre pressed grainy salt such as NaCl, formed as a block and free of any containers, was penetrated only 12 mm A reduction of penetration depth by 85% was obtained.

In a second experiment grainy salt was pressed in a steel container, formed as a pipe having a diameter of 80 mm, the pipe having a wall thickness of 3 mm. The used pressure was 23 metric tons per square centimetre. A RKG/3 hand grenade was tested. The hand grenade contains 370 grams C6. Testing revealed a 60 cm penetration depth in iron. The armour layer according to the invention, on top of a iron armour layer, tested at 6 cm penetration in the iron layer, a reduction of 90%.

In a third experiment a BLU-755 was tested on a similar layer enclosed in a similar steel pipe. The BLU-755 has a penetration depth of 32 cm in hardened steel armour. In an uncompressed NaCl layer on top of an iron layer, the penetration depth in the iron layer was less than 5 cm.

FIG. 2B shows a basic armour plate 23 according the invention. It comprises an container 20 and filler material 21. In an embodiment, the basic armour plate 23 further comprises additional support structures 22, for example to make the container more rigid, or to limit the filler material moving inside the container. The basic armour plate has a width w, a length l, and a height or thickness h.

FIG. 2C shows alternative containers with a cell structure, where the cells 25 have a hexagonal shape. The cells are filled with fine grained material 26. The cell structure can also be used as a support structure inside an container, as in FIG. 2B.

In an embodiment according the invention, the filler material 21 surrounds further objects. For example, spheres of hardened steel or glass may be mixed in with the filler material. The inventors believe these spheres may have an additional stopping effect on shaped charge jets. Other shapes than spheres and other materials than steel or glass may be used as well.

FIG. 3A shows a cross section of a combined armour plate 39 according the invention. On the outside a rigid or flexible outside layer 30 made of for example steel or plastic is provided as part of the container 20. Underneath a layer of filler material 31 is provided. Underneath that layer, an optional intermediate layer 32 is provided to separate the filler material 31 from the traditional armour layer 33. Traditional armour layer 33 may comprise standard armour elements, such as steel plates. The filler material 31 may be a chemical salt. In an embodiment, the filler material 31 is NaCl. In a further embodiment, the filler material is compressed. The layer of filler material 31 may also provide a support structure 34. The support structure 34 may consists of strut-like elements, at either end connected to the container material, or straight or curved surfaces, also connected to the container material. Many variations of support elements are possible.

The armour functions as follows. The top side, with outside layer 30, is the outside of the armour and thus the side where incoming projectiles, such as shaped charges, will impact. Consider a shaped charge projectile coming from the direction indicated as i in FIG. 3A. Upon impact, the shaped charge jet will be formed, as described in reference to FIG. 1, and the outside layer 30, in an embodiment according the invention not provided with penetration resisting measures, is likely penetrated by the jet.

Next the jet will attempt to penetrate the layer of filler material 31. The filler stopping effect described in reference to FIG. 2A will reduce the velocity of the jet, or stop the jet altogether.

If the jet is not stopped altogether, it may continue to penetrate intermediate layer 32. After that, it is up to the traditional armour layer 33 to stop the jet. Because the filler stopping effect has already slowed down the incoming jet to some extent, the chances of the traditional armour layer stopping the incoming jet are improved. In fact, it may be so that the jet never reaches the traditional armour layer.

It is an advantage of the support structure 34 that it will help to maintain the integrity of the filler layer at the moment of impact.

FIG. 3B shows an enhancement of the embodiment in FIG. 3A, using known measures against shaped charge explosives from U.S. Pat. No. 6,311,605. On the outer layer protruding elements 35 are provided, which are arranged to penetrate the standoff distance of the shaped charge explosive.

The function of these elements on the outer layer 30 is to hinder the shaped charge explosive from detonating at its ideal standoff distance from the target surface, which is in this case the outer layer 30. If the ideal standoff distance is not achieved, the shaped charge jet will not reach its optimal velocity, and thus the penetration of the jet in the armour will be somewhat limited.

FIG. 3C shows an alternative enhancement of the embodiment in FIG. 3A, using other known measures against shaped charge explosives from U.S. Pat. No. 6,581,504. On the outer layer a structure is added with inclined plates 37 supported by struts 38.

Again the structure on top of outer layer 30 is meant to cause the incoming shaped charge projectile to detonate in such a manner that the ideal standoff distance, required for optimal penetration of outer layer 30 and the layers underneath, is not realized.

As indicated in the introduction, there has been a lot of research into measures against shaped charge explosives. Many of these measures may be combined together with filler material in an embodiment according the invention.

FIG. 4 shows an armoured vehicle 40 with added basic armour plates 23 according to the invention. In an embodiment, these basic armour plates 23 are added on the outside of existing armour. In another embodiment, combined armour plates 39 are added on the outside of existing armour. In yet another embodiment, the layer 31 containing the filler material is an integral part of the vehicle armour, such as the combined armour 39 plates described in reference to FIGS. 3A-C.

The armour plates 23 or 39 may be attached using a variety of means available to a skilled person. For example, they may be attached using nuts and bolts, welding connections, or other means. In an embodiment, the armour plates 23 or 39 are connected at some distance from the underlying armour, the connection means being for example a rod. Thus, around the rod connecting the plate to the underlying vehicle armour, there is a layer of air. This technique is known as “spaced armour” and is yet another example of a measure to interfere with the ideal stand-off distance of the shaped charge explosive.

It will be clear to a skilled person that the added basic 23 or added combined 39 armour plates or fully integrated armour plates 39 can be used to protect all sorts of vehicle, both military an civilian. Armour plates can for example also be used to protect static structures, such as buildings or stationary equipment.

FIG. 5 shows an reinforced door 59 with a filler material layer 51 between standard reinforced plates 50, 52. Plates 50 and 52 form the front and back sides of the door. Reinforced elements 54 and 55 may be used to connect the reinforced plates 50 and 52, thus also forming an container 50, 52, 54, 55 for the filler material layer 51. Support structure 56 between the reinforced plates 50 and 52, surrounded by filler material layer 51, may be provided to limit movement of the filler material or to improve overall robustness of the door 59, or for other reasons.

The door 59 is thus better protected against shaped charge explosives. If for example, one attempts to make a hole by placing and detonating a shaped charge explosive on the outer surface 53 of reinforced layer 50, the shaped charge jet may first travel through the reinforced layer 50, after which the filler stopping effect will slow the jet down or stop the jet altogether.

To a person skilled in the art, other embodiments of doors will be obvious. For example, a door to a safe, where intrusion attempts are only expected from the outside, may comprise a single reinforced layer 50 and a filler material layer 51. The layer 52 may then be a non-reinforced layer meant for enclosing the filler material layer 51.

It will also be obvious to a skilled person that the armour layers 50, 51, 52, of the door 59 can be used in other configurations, for example to protect walls, floors, and other structural elements. Similarly, depending on the application and the desired protection, the order of armour elements can be changed, for example layers 50 and 52 may comprise enclosures and filler material, while layer 51 may comprise traditional steel armour.

FIG. 6A shows an personnel protection vest 60 provided with armour elements 61 according to the invention. These armour elements 61 can be basic armour plates 23. The armour elements 61 may also be combined armour plates 39, where the traditional armour layer 33 for example comprises Kevlar material.

The armour elements may be attached in various ways. They can for example be sown in fabric, or attached using nail like connection elements.

The function of the armour plates is similar to functions described in reference to FIGS. 2-5. In the case of a personnel protection vest to be worn, the projectiles to be stopped may also comprise rifle bullets and other relatively small, compared to grenades, projectiles.

FIG. 6B shows a variation of FIG. 6A, where the armour elements 65 are arranged such that they partially overlap “samurai style”. To the skilled person, other arrangements of armour elements, including armour elements that are not shaped as plates, will be known.

It should be noted that the abovementioned embodiments and examples illustrate rather than limit the invention, and that those skilled in the art will be able to design many alternative embodiments without departing from the scope of the appended claims.

1-24. (canceled)

25. Armour (23, 39) for protecting an object from a projectile comprising a layer of granulate salt (21, 26, 31, 51) at least partially surrounding the object.

26. The armour (23, 39) according to claim 25, wherein the granulate salt (21, 26, 31, 51) is dielectric salt.

27. The armour (23, 39) according to claim 25, wherein the granulate salt (21, 26, 31, 51) is predominantly ionic, at least 70%.

28. The armour (23, 39) according to claim 25, wherein the salt (21, 26, 31, 51) has a cubic crystal structure or an interpenetrating face-centred cubic lattice or an fca lattice with a two atom basis.

29. The armour (23, 39) according to claim 25, wherein the salt (21, 26, 31, 51) comprises one or more cations of alkali metals, in particular Sodium (Na) or Lithium (Li), or Calcium (Ca), or Magnesium (Mg), or Potassium (K), preferably a one atom cation.

30. The armour (23, 39) according to claim 25, wherein the salt (21, 26, 31, 51) comprises one or more anions of halogens, in particular Chlorine (Cl) or Nitrate (NO2), Sulfate (SO4), or phosphate (PO4), preferably a one atom anion.

31. The armour (23, 39) according to claim 25, wherein the granulate salt (21, 26, 31, 51) is Sodium Chloride (NaCl.)

32. The armour (23, 39) according to claim 25, wherein the salt (21, 26, 31, 51) has a Molar mass of less than 180 gr/Mol, preferably less than 140 gr/Mol, more preferably less than 100 gr/Mol.

33. The armour (23, 39) according to claim 25, wherein the salt (21, 26, 31, 51) has a Mohs hardness of less than 6, preferably less than 5.

34. The armour (23, 39) according to claim 25, wherein the salt (21, 26, 31, 51) forms a layer with a hardness that is smaller than 20 Vickers.

35. The armour (23, 39) according to claim 25, wherein the granulate salt (21, 26, 31, 51) is pressed.

36. The armour (23, 39) according to claim 25, wherein the salt (21, 26, 31, 51) is received in an enclosure or container (20, 25, 30).

37. The armour (23, 39) according to claim 36, wherein the granulate salt (21, 26, 31, 51) is pressed in the container (20, 25, 30).

38. The armour (23, 39) according to claim 36, wherein the container (20, 25, 30) is made of a rigid material, such as steel or a plastic.

39. The armour (23, 39) according to claim 25, wherein the armour is arranged for the protection of a vehicle or static structure or arranged for the protection of a person's body, and preferably arranged in overlapping “roof-tile” manner.

40. The armour (23, 39) according to claim 25, wherein the layer of salt (21, 26, 31, 51) forms a passive armour layer.

41. The armour (23, 39) according to claim 25, wherein the layer of salt (21, 26, 31, 51) comprises at most 10%, preferably at most 20%, more preferably at most 30% of an additional material.

42. The armour (23, 39) according to claim 41, wherein the additional material comprises any one or a combination of the materials sodium hydroxide, mortar, graphite, carbon, activated carbon, granular activated carbon, sugar, lead, zinc, copper, tombak, nitrates, clay, loam, lime, and calcium.

43. Combined armour plate (39), comprising
a first layer of granulate material (31), wherein the granulate material is compressed with a pressure of at least 2 Atm, said granulate material comprising at least 50%, preferably 75%, more preferably 90% salt, and
a second layer of traditional armour (33),
wherein the first layer (31) is located closer to the outside or impact side of the armour plate than the second layer (33).

44. Method of forming an armour (23, 39) comprising providing a granulate salt (21, 26, 31, 51) and pressing the granulate salt in a container (22, 25 30).

45. The method according to claim 44, wherein the granulate salt comprises an additional material comprised of any one or a combination of sodium hydroxide, mortar, graphite, carbon, activated carbon, granular activated carbon, sugar, lead, zinc, copper, tombak, nitrates, clay, loam, lime, and calcium.
